(19) United States
(12) Patent Application Publication
(10) Pub. No.: US 2011/0154995 A1
(43) Pub. Date: Jun. 30, 2011

(54) AUTOMATIC BREAD MAKER

(76) Inventors: Takashi WATANABE, Tottori City (JP); Masayuki Shimozawa, Tottori City (JP)

(21) Appl. No.: 12/977,529

(22) Filed: Dec. 23, 2010

(30) Foreign Application Priority Data
Dec. 25, 2009 (JP) JP 2009-294461

(51) Int. Cl. A21B 7/00

(52) U.S. Cl. 99/348

(57) ABSTRACT

An automatic bread maker includes a container in which bread ingredients are fed, a main body which receives the container and is equipped with a motor, and a control unit which controls to perform a bread making process in a state where the container is received by the main body. The bread making process includes a grinding step of grinding grains in the container by driving the motor, and a kneading step of kneading bread ingredients in the container including the ground flour of the grains into bread dough by driving the motor. The control unit monitors a load of the motor so as to decide end of the active step on the basis of the load in at least one of the grinding step and the kneading step.

### CROSS-REFERENCE TO RELATED APPLICATIONS

This application is based on Japanese Patent Application No. 2009-294461 filed on Dec. 25, 2009, the contents of which are hereby incorporated by reference.

### BACKGROUND OF THE INVENTION

1. Field of the Invention

The present invention relates to an automatic bread maker that is used typically in a home.

2. Description of Related Art

The most available automatic bread maker for home use has generally a structure in which a bread container of bread ingredients is used as a baking mold as it is for making bread (see, for example, JP-A-2000-116526). In such an automatic bread maker, the bread container with bread ingredients is set first in a baking chamber of a main body. Then, the bread ingredients in the bread container is mixed and kneaded by a mixing and kneading blade disposed in the bread container to be bread dough (kneading step). After that, the kneaded bread dough is fermented in a fermentation step, and then bread is baked using the bread container as a baking mold (baking step).

Conventionally, when the automatic bread maker is used for making bread, it is necessary to use milled flour of wheat, rice or the like (wheat flour, rice flour, or the like), or mix powder of the milled flour and various supplement ingredients.

Here, in an ordinary home, instead of flour, grains such as rice may be stocked. Therefore, it is convenient if the automatic bread maker can use for making bread directly from grains. As to this point, the applicants have already invented a method of making bread from grains after earnest research and filed a patent application (Japanese patent application No. 2008-201507).

Here, the method of making bread disclosed in the above-mentioned application is described. In this method of making bread, grains are mixed with liquid first, and the mixture is ground by grinding blades (grinding step). Then, the bread ingredients including the paste-like ground flour obtained by the grinding step is kneaded into dough (kneading step), and fermentation of the dough is performed (fermentation step). After that, the fermented dough is baked into bread (baking step).

However, the automatic bread maker using the above-mentioned process is currently under development stage, and there is a case where quality of bread may have variation when the automatic bread maker is used for making bread from grains. It is considered that such a variation is due to a change of environment where the automatic bread maker is placed, or a variation of hardness of grains that are used as ingredients, for example. The automatic bread maker that can make bread from grains has a merit that making bread in home becomes more useful. However, if quality of the bread is unstable as described above, it may discourage users from making bread in home.

### SUMMARY OF THE INVENTION

Therefore, an object of the present invention is to provide an automatic bread maker that can make bread with good quality from grains in a stable manner.

In order to achieve the above-mentioned object, an automatic bread maker according to the present invention includes a container in which bread ingredients are fed, a main body which receives the container and is equipped with a motor, and a control unit which controls to perform a bread making process in a state where the container is received by the main body. The bread making process includes a grinding step of grinding grains in the container by driving the motor, and a kneading step of kneading bread ingredients in the container including the ground flour of the grains into bread dough by driving the motor. The control unit monitors a load of the motor so as to decide end of the active step on the basis of the load in at least one of the grinding step and the kneading step.

When the automatic bread maker is used for making bread from grains, there may be variations in grading of the ground flour obtained when the grinding step is finished or of the bread dough obtained when the kneading step is finished, due to a variation of hardness of grains or a change in environment of the automatic bread maker (temperature, for the most part), for example. Concerning this point, with the structure of the present invention, end points of the grinding step and/or the kneading step are decided on the basis of a load of motor. Therefore, the state of the bread ingredients (or the bread dough) when the grinding step (or the kneading step) is finished can be stabilized. Note that it is preferable to adopt a structure in which the end point is decided on the basis of a load of motor in both the grinding step and the kneading step.

In the automatic bread maker having the above-mentioned structure, the bread making process may further include a fermentation step of fermenting the kneaded bread dough and a baking step of baking the fermented bread dough.

In the automatic bread maker having the above-mentioned structure, it is preferable that the bread making process further includes a pre-grinding liquid absorption step of allowing the grains in the container to absorb liquid before the grinding step. According to this structure, it is possible to grind the grains finely because the grinding is performed in the state where liquid (water, typically) is absorbed into the grains.

In the automatic bread maker having the above-mentioned structure, it is preferable that the bread making process further includes a post-grinding liquid absorption step of allowing the ground flour of the grains in the container to absorb liquid between the grinding step and the kneading step. According to this structure, it is possible to make bread without cooling device because the post-grinding liquid absorption step ensure a period for cooling the ground flour whose temperature has been raised in the grinding step. Therefore, according to this structure, it is possible to reduce cost necessary for the automatic bread maker. In addition, it can be expected that the ground flour is further broken by the post-grinding liquid absorption step, so that amount of fine grains increases. Therefore, according to this structure, it is possible to bake bread with delicate and good quality (taste).

It is preferable that the automatic bread maker having the above-mentioned structure further includes a temperature detection unit capable of detecting at least one of ambient temperature, temperature of the container, surrounding temperature of the container, and temperature of the bread ingredients in the container, and that the plurality of steps performed when the bread making process is performed include at least one step whose time period is changed on the basis of temperature detected by the temperature detection unit.

Note that in this specification, the term “temperature of the bread ingredients” is widely used as temperature of ingredients for making bread regardless of the state thereof before the bread is baked. Therefore, the term “temperature of the bread ingredients” may include temperature of the bread dough obtained by mixing and kneading the bread ingredients.

As a factor of variation in quality of bread made from grains, there is a variation of ambient temperature and temperature of water or the like that is used depending on the environment of the automatic bread maker. Concerning this point, the automatic bread maker having this structure is equipped with a temperature detection unit capable of detecting at least one of ambient temperature, temperature of the container in which the bread ingredients are fed, surrounding temperature of the container, and temperature of the bread ingredients in the container. Further, in this structure, the plurality of steps performed when the bread making process is performed include at least one step whose time period is changed on the basis of temperature detected by the temperature detection unit. Therefore, it is possible to reduce possibility that quality of bread varies depending on ambient temperature or the like.

In the automatic bread maker having the above-mentioned structure, the motor may include a grinding motor that is used in the grinding step and a mixing and kneading motor that is used in the kneading step.

According to the present invention, it is possible to provide an automatic bread maker that can make bread with good quality from grains in a stable manner. Therefore, according to the present invention, making bread in home becomes more familiar.

### BRIEF DESCRIPTION OF THE DRAWINGS

FIG. 1 is a vertical cross section of an automatic bread maker according to this embodiment.

FIG. 2 is a partial vertical cross section obtained by cutting the automatic bread maker of this embodiment illustrated in FIG. 1 in the direction perpendicular to FIG. 1.

FIG. 3 is a schematic perspective view illustrating structures of a grinding blade and a mixing and kneading blade of the automatic bread maker according to this embodiment.

FIG. 4 is a schematic plan view illustrating structures of the grinding blade and the mixing and kneading blade of the automatic bread maker of this embodiment.

FIG. 5 is a top view of a bread container in the case where the mixing and kneading blade is folded in the automatic bread maker of this embodiment.

FIG. 6 is a top view of the bread container in the case where the mixing and kneading blade is extended in the automatic bread maker of this embodiment.

FIG. 7 is a schematic plan view illustrating a state of a clutch in the case where the mixing and kneading blade is extended in the automatic bread maker of this embodiment.

FIG. 8 is a control block diagram of the automatic bread maker of this embodiment.

FIG. 9 is a schematic diagram illustrating a process flow of a bread making process for rice grains in the automatic bread maker of this embodiment.

FIG. 10 illustrates an example of a table for determining time period of a pre-grinding water absorption step in association with temperature, which is used in the automatic bread maker of this embodiment.

FIG. 11 is a flowchart illustrating a detailed process flow of a grinding step performed in the automatic bread maker of this embodiment.

FIG. 12 is a flowchart illustrating a detailed process flow of a post-grinding water absorption step performed in the automatic bread maker of this embodiment.

FIG. 13 is a flowchart illustrating a detailed process flow of a kneading step performed in the automatic bread maker of this embodiment.

FIG. 14 is a flowchart illustrating a detailed process flow of a fermentation step performed in the automatic bread maker of this embodiment.

### DETAILED DESCRIPTION OF THE PREFERRED EMBODIMENTS

Hereinafter, an embodiment of the automatic bread maker according to the present invention will be described in detail with reference to the attached drawings. Note that the concrete time and temperature in this specification are merely examples, which do not limit the scope of the present invention.

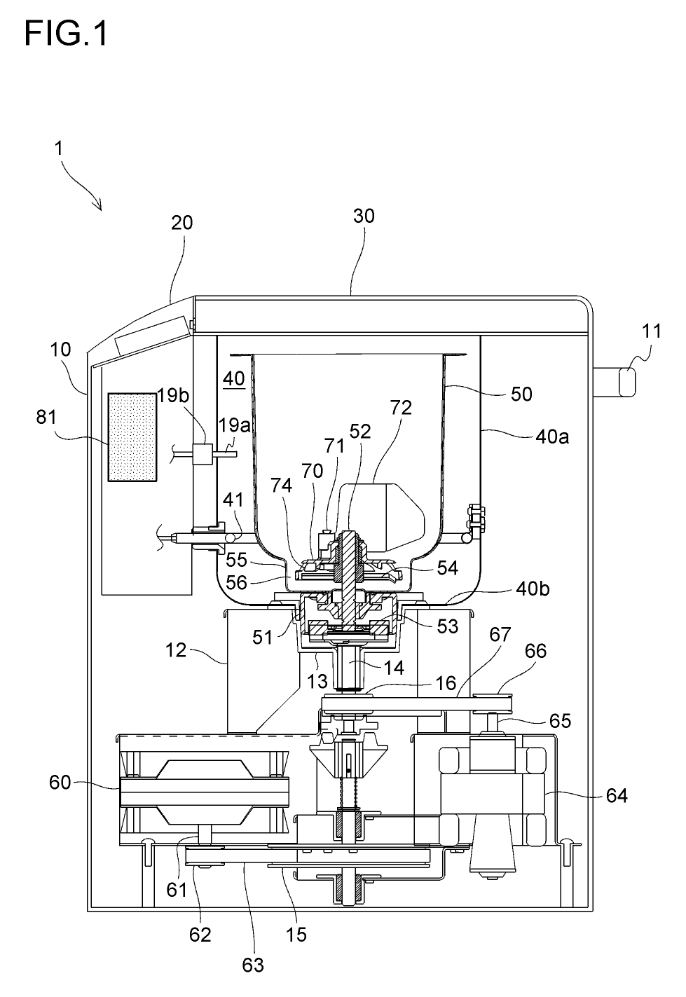

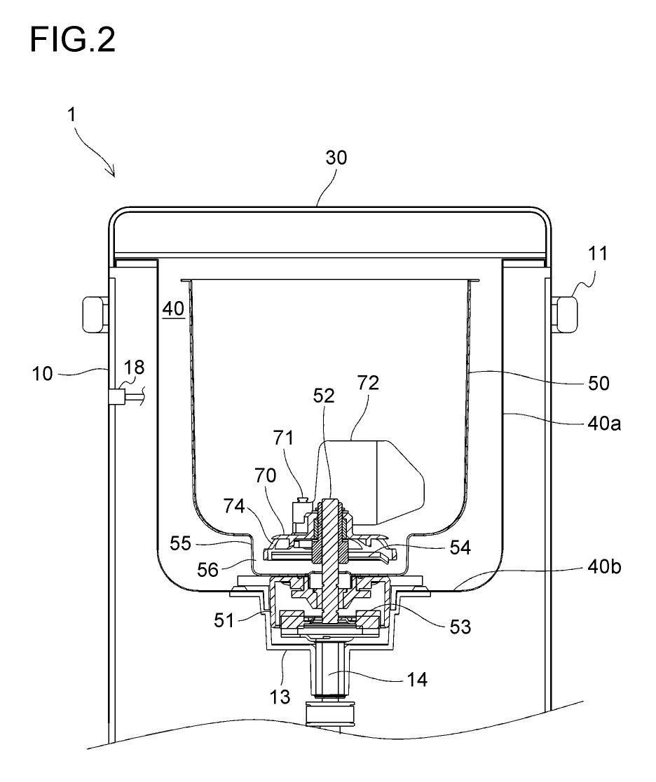

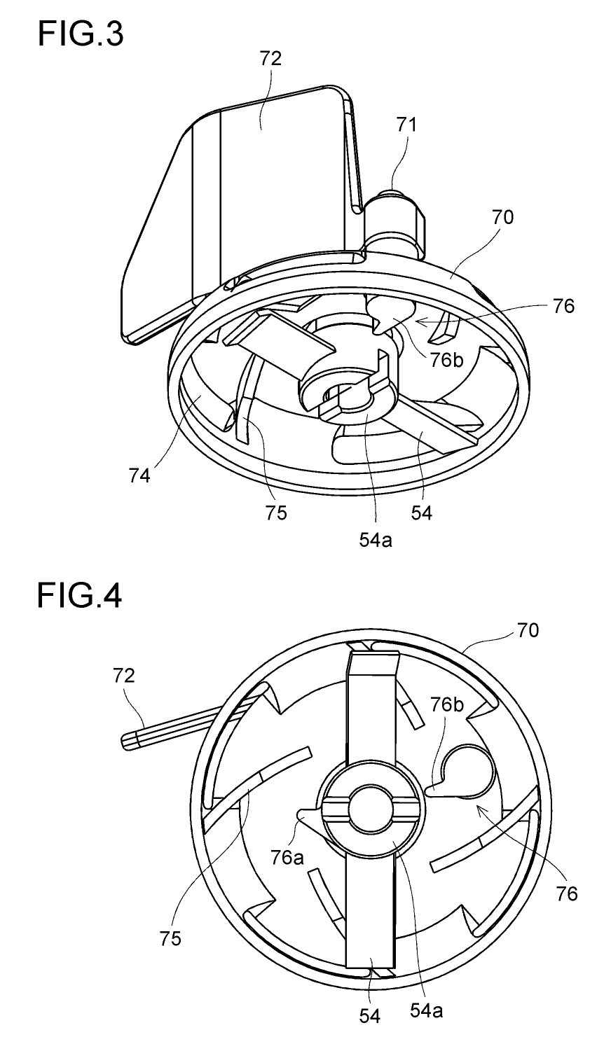

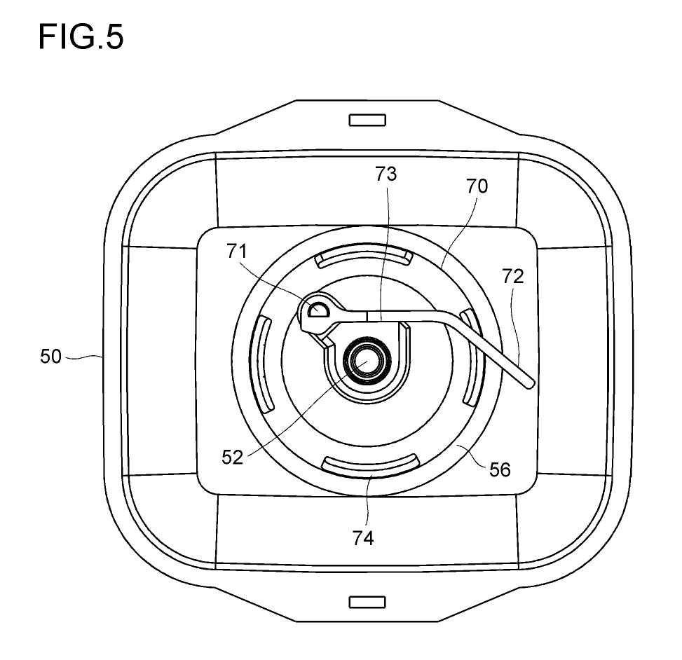

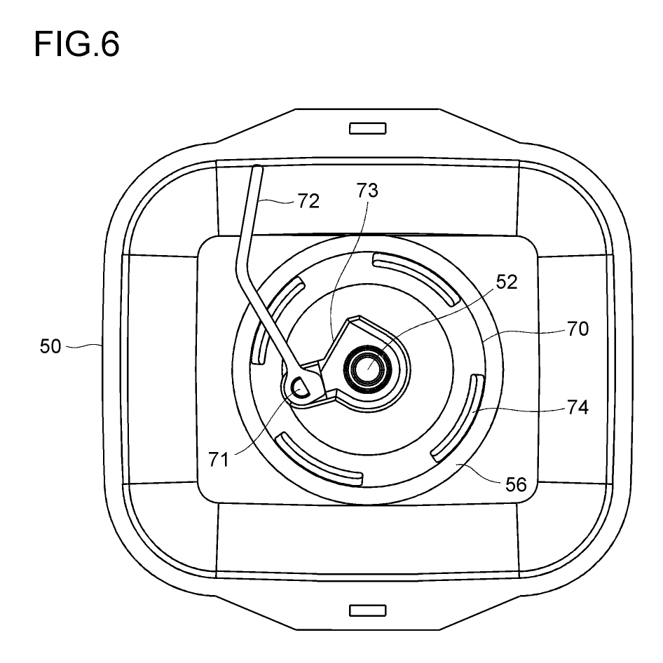

FIG. 1 is a vertical cross section of the automatic bread maker of this embodiment. FIG. 2 is a partial vertical cross section obtained by cutting the automatic bread maker of this embodiment illustrated in FIG. 1 in the direction perpendicular to FIG. 1. FIG. 3 is a schematic perspective view illustrating structures of a grinding blade and a mixing and kneading blade of the automatic bread maker according to this embodiment, which is viewed diagonally from below. FIG. 4 is a schematic plan view illustrating structures of the grinding blade and the mixing and kneading blade of the automatic bread maker of this embodiment, which is viewed from below. FIG. 5 is a top view of a bread container in the case where the mixing and kneading blade is folded in the automatic bread maker of this embodiment. FIG. 6 is a top view of the bread container in the case where the mixing and kneading blade is extended in the automatic bread maker of this embodiment. Hereinafter, a general structure of the automatic bread maker will be described with reference to FIGS. 1 to 6 mainly.

Note that in the following description, the left side in FIG. 1 corresponds to the front side of the automatic bread maker 1, and the right side in FIG. 1 corresponds to the rear side of the automatic bread maker 1. In addition, the left hand side of a viewer facing the front of the automatic bread maker 1 corresponds to the left side of the automatic bread maker 1, and the right hand side of the viewer corresponds to the right side of the automatic bread maker 1.

The automatic bread maker 1 has a box-type main body 10 constituted of an outer shell made of synthetic resin. The main body 10 is provided with a U-shaped handle 11 made of synthetic resin that is connected to the left side and the right side of the main body 10 at both ends, so that the automatic bread maker 1 can be carried easily. An operating portion 20 is provided to the front part of the upper surface of the main body 10. In the operating portion 20, although not illustrated, there are provided an operating key group including a start key, a cancel key, a timer key, a reservation key, and a selection key for selecting a bread making course (rice flour bread course, wheat flour bread course, and the like), and a display unit that displays an item set by the operating key group, an error, or the like. Note that the display unit is constituted of a liquid crystal display panel and display lamps using light emitting diodes as light sources.

The upper surface of the main body is covered with a lid 30 made of synthetic resin in the rear part of the operating portion 20. The lid 30 is attached to the back side of the main body 10 with a hinge axis (not shown) and can swing about the hinge axis in the vertical plane. Note that the lid 30 is provided with an observation window (not shown) made of heat-resistant glass, through which the user can see the inside of a baking chamber 40 that will be described below.

Inside the main body 10, there is disposed a baking chamber 40. The baking chamber 40 is made of metal sheet and has an opening in the upper surface, through which a bread container 50 is set in the baking chamber 40. The baking chamber 40 has a peripheral sidewall 40a having a rectangular horizontal cross section and a bottom wall 40b. In the baking chamber 40, there is arranged a sheath heater 41 so as to surround the bread container 50 set in the baking chamber 40, so that bread ingredients inside the bread container 50 can be heated.

In addition, a pedestal 12 made of metal sheet is disposed inside the main body 10. The pedestal 12 is provided with a bread container bearing member 13 made of aluminum alloy by die casting process, which is fixed to the position corresponding to the center of the baking chamber 40. The inside of the bread container bearing member 13 is exposed to the inside of the baking chamber 40.

At the center of the bread container bearing member 13, a driving shaft 14 is supported vertically. A torque is transmitted to the driving shaft 14 via pulleys 15 and 16. A clutch is disposed between the pulley 15 and the driving shaft 14, as well as between the pulley 16 and the driving shaft 14. Therefore, when the pulley 15 is rotated in one direction so that the torque is transmitted to the driving shaft 14, the rotation of the driving shaft 14 is not transmitted to the pulley 16. Further, when the pulley 16 is rotated in the direction opposite to the pulley 15 so that the torque is transmitted to the driving shaft 14, the rotation of the driving shaft 14 is not transmitted to the pulley 15.

The pulley 15 is rotated by a mixing and kneading motor 60 that is fixed to the pedestal 12. The mixing and kneading motor 60 has a vertical axis, and its output shaft 61 protrudes from the underside thereof. A pulley 62 is fixed to the output shaft 61 and is linked to the pulley 15 via a belt 63. The mixing and kneading motor 60 itself is a low speed and high torque type. In addition, since the pulley 62 rotates the pulley 15 at a reduced speed, the driving shaft 14 rotates at a low speed and a high torque.

The pulley 16 is rotated by a grinding motor 64 that is also fixed to the pedestal 12. The grinding motor 64 also has a vertical axis, and its output shaft 65 protrudes from the top surface. A pulley 66 is fixed to the output shaft 65 and is linked to the pulley 16 via a belt 67. The grinding motor 64 has a role of providing high speed rotation to the grinding blade that will be described later. Therefore, a high speed motor is selected as the grinding motor 64, so that a reduction gear ratio between the pulley 66 and the pulley 16 becomes substantially 1:1.

The bread container 50 is made of metal sheet and has a bucket-like shape with a handle for carrying by hand (not shown), which is attached to the opening rim thereof. The horizontal cross section of the bread container 50 has a rounded rectangular shape. In addition, the bottom face of the bread container 50 has a recess 55 formed for housing a grinding blade 54 and a cover 70 that will be described later in detail. The recess 55 has a circular shape in a plan view, and there is a gap space 56 between the periphery of the cover 70 and the inner surface of the recess 55, which allows the bread ingredients to flow. In addition, a tubular pedestal 51 made of aluminum alloy by die casting process is provided to the bottom surface of the bread container 50. The bread container 50 is set in the baking chamber 40 in the state where the pedestal 51 is received by the bread container bearing member 13.

A blade rotation shaft 52 extending in the vertical direction is supported in the center of the bottom of the bread container 50 with seal means. A torque is transmitted to the blade rotation shaft 52 from the driving shaft 14 via a coupling 53. The coupling 53 is constituted of two members, and one of them is fixed to the lower end of the blade rotation shaft 52 while the other member is fixed to the upper end of the driving shaft 14. The entire coupling 53 is enclosed by the pedestal 51 and the bread container bearing member 13.

The inner circumferential surface of the bread container bearing member 13 and the outer circumferential surface of the pedestal 51 are respectively provided with protrusions (not shown), which constitute a well-known bayonet coupling. In particular, when the bread container 50 is coupled to the bread container bearing member 13, the bread container 50 is put downward so that the protrusion of the pedestal 51 does not interfere with the protrusion of the bread container bearing member 13. Then, after the pedestal 51 is fit in the bread container bearing member 13, the bread container 50 is turned in the horizontal direction so that the protrusion of the pedestal 51 is engaged with the lower surface of the protrusion of the bread container bearing member 13. Thus, the bread container 50 cannot be removed upward. In addition, this operation also makes connection of the coupling 53.

Note that the direction of turning the bread container 50 when it is coupled is agreed with the rotation direction of a mixing and kneading blade 72 that will be described later, so that the bread container 50 is not detached when the mixing and kneading blade 72 is rotated.

The grinding blade 54 is connected to the blade rotation shaft 52 at a position a little above the bottom of the bread container 50. The grinding blade 54 is connected to the blade rotation shaft 52 in a non-rotatable manner. The grinding blade 54 is made of stainless steel sheet. As illustrated in FIGS. 3 and 4, the grinding blade 54 has a shape like a propeller of an airplane (this shape is merely an example). The grinding blade 54 can be detached from the blade rotation shaft 52 by pulling the same, so that it can easily be cleaned after the bread making process or can easily be replaced when it goes blunt.

The dome-like cover 70 having a circular shape in a plan view is attached to the upper end of the blade rotation shaft 52. The cover 70 is made of aluminum alloy by die casting process and is received by a hub 54a of the grinding blade 54 so as to cover the grinding blade 54. This cover 70 can also be pulled off from the blade rotation shaft 52 easily, so that it can be easily cleaned after the bread making process.

The mixing and kneading blade 72 having an L-shape in a plan view is attached to an upper outer surface of the cover 70 by a support shaft 71 that is disposed separated from the blade rotation shaft 52 and extends in the vertical direction. The mixing and kneading blade 72 is made of aluminum alloy by die casting process. The support shaft 71 is fixed or integrated to the mixing and kneading blade 72, so as to move together with the mixing and kneading blade 72.

The mixing and kneading blade 72 rotates in the horizontal surface about the support shaft 71, and is movable between a folded position illustrated in FIG. 5 and an extended position illustrated in FIG. 6. In the folded position, the mixing and kneading blade 72 abuts a stopper portion 73 formed on the cover 70, so that it cannot move further in the clockwise direction with respect to the cover 70. In this state, the tip of the mixing and kneading blade 72 protrudes a little from the cover 70. In the extended position, the tip of the mixing and kneading blade 72 is apart from the stopper portion 73 so that the tip of the mixing and kneading blade 72 protrudes largely from the cover 70.

Note that the cover 70 is provided with windows 74 communicating the space inside the cover with the space outside the cover, and ribs 75 formed on the inner surface corresponding to individual windows 74 so as to guide the ingredients ground by the grinding blade 54 toward the window 74. With this structure, grinding efficiency using the grinding blade 54 is enhanced.

A clutch 76 is disposed between the cover 70 and the blade rotation shaft 52 as illustrated in FIG. 4. The clutch 76 connects the blade rotation shaft 52 with the cover 70 in the rotation direction of the blade rotation shaft 52 when the mixing and kneading motor 60 rotates the driving shaft 14 (this rotation direction is referred to as a “normal direction rotation”). On the contrary, the clutch 76 disconnects between the blade rotation shaft 52 and the cover 70 in the rotation direction of the blade rotation shaft 52 when the grinding motor 64 rotates the driving shaft 14 (this rotation direction is referred to as a “reverse direction rotation”). Note that in FIGS. 5 and 6, the “normal direction rotation” is a counterclockwise direction rotation, and the “reverse direction rotation” is a clockwise direction rotation.

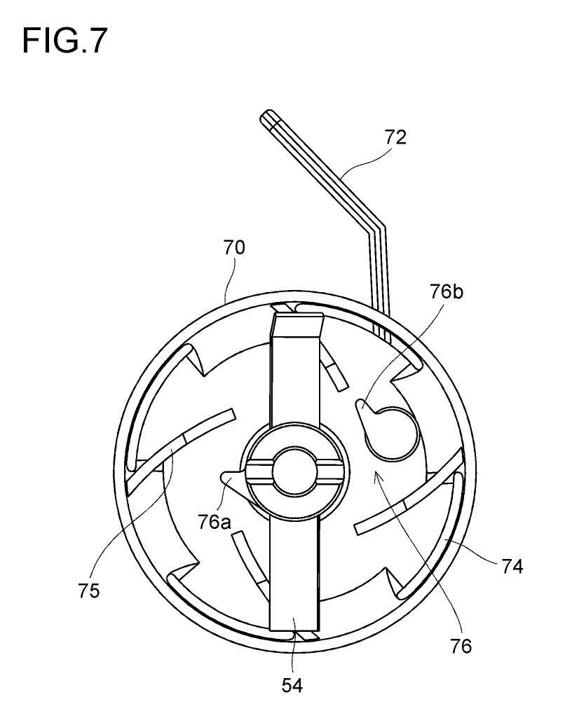

The clutch 76 switches the connection state in accordance with the position of the mixing and kneading blade 72. Specifically, when the mixing and kneading blade 72 is in the folded position illustrated in FIG. 5, a second engaging member 76b interferes with the rotation path of a first engaging member 76a as illustrated in FIG. 4. Therefore, when the blade rotation shaft 52 rotates in the normal direction, the first engaging member 76a engages with the second engaging member 76b so that the torque of the blade rotation shaft 52 is transmitted to the cover 70 and the mixing and kneading blade 72. On the contrary, when the mixing and kneading blade 72 is in the extended position illustrated in FIG. 6, the second engaging member 76b is out of the rotation path of the first engaging member 76a as illustrated in FIG. 7. Therefore, when the blade rotation shaft 52 rotates in the reverse direction, the first engaging member 76a does not engage with the second engaging member 76b. Therefore, the torque of the blade rotation shaft 52 is not transmitted to the cover 70 and the mixing and kneading blade 72. Note that FIG. 7 is a schematic plan view illustrating a state of the clutch when the mixing and kneading blade is in the extended position.

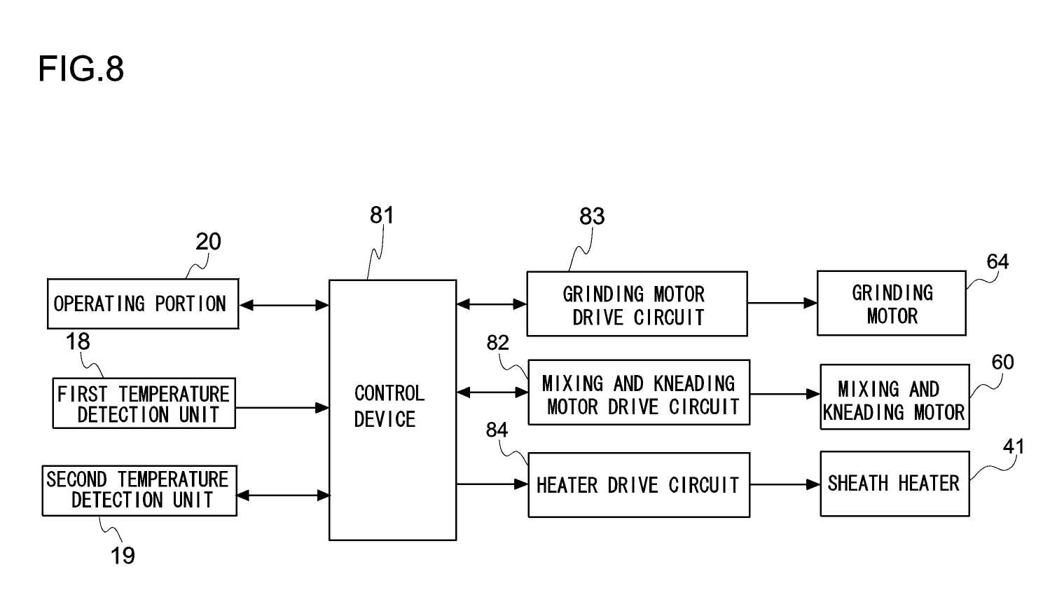

FIG. 8 is a control block diagram of the automatic bread maker of this embodiment. As illustrated in FIG. 8, the control action in the automatic bread maker 1 is performed by the control device 81. The control device 81 is constituted of a microcomputer including a central processing unit (CPU), a read only memory (ROM), a random access memory (RAM), an input/output (I/O) circuit unit, and the like. It is preferable that the control device 81 is disposed in a position that is hardly affected by heat of the baking chamber 40. In the automatic bread maker 1, the control device 81 is disposed between the front sidewall of the main body 10 and the baking chamber 40.

The control device 81 is electrically connected to a first temperature detection unit 18, a second temperature detection unit 19, the operating portion 20 described above, a mixing and kneading motor drive circuit 82, a grinding motor drive circuit 83, and a heater drive circuit 84.

The first temperature detection unit 18 is a temperature sensor that is disposed on the side surface of the main body 10 as illustrated in FIG. 2, so that it can detect ambient temperature. The second temperature detection unit 19 includes a temperature sensor 19a and a solenoid 19b as illustrated in FIG. 1, so that the tip of the temperature sensor 19a protrudes from the front sidewall of the baking chamber 40 into the baking chamber 40. The tip position of the temperature sensor 19a can be switched by the solenoid 19b between a position contacting with the bread container 50 and a position apart from the same. Note that FIG. 1 illustrates the case where the tip of the temperature sensor 19a is at the position apart from the bread container 50. By switching the tip position of the temperature sensor 19a, the second temperature detection unit 19 can selectively detect temperature inside the baking chamber 40 (as an example of surrounding temperature of the container in the present invention) and temperature of the bread container 50.

The mixing and kneading motor drive circuit 82 is a circuit that controls drive of the mixing and kneading motor 60 in accordance with an instruction from the control device 81. In addition, the grinding motor drive circuit 83 is a circuit that controls drive of the grinding motor 64 in accordance with an instruction from the control device 81. The heater drive circuit 84 is a circuit that controls an action of the sheath heater 41 in accordance with an instruction from the control device 81.

The control device 81 reads out a program for the bread making process stored in the ROM or the like in accordance with an input signal from the operating portion 20. Then, the control device 81 controls rotation of the mixing and kneading blade 72 via the mixing and kneading motor drive circuit 82, rotation of the grinding blade 54 via the grinding motor drive circuit 83, and heating action of the sheath heater 41 via the heater drive circuit 84, while it controls the automatic bread maker 1 to perform the bread making process. In addition, the control device 81 has a time measuring function so that temporal control can be performed in the bread making process.

Note that the control device 81 corresponds to an embodiment of the control unit of the present invention. In addition, the mixing and kneading blade 72, the mixing and kneading motor 60, and the mixing and kneading motor drive circuit 82 correspond to an example of a mixing and kneading unit. In addition, the grinding blade 54, the grinding motor 64, and the grinding motor drive circuit 83 correspond to an example of a grinding unit. In addition, the sheath heater 41 and the heater drive circuit 84 correspond to an example of a heating unit. In addition, the first temperature detection unit 18 and the second temperature detection unit 19 correspond to an embodiment of the temperature detection unit of the present invention.

The automatic bread maker of this embodiment 1 having the above-mentioned structure is adapted to be capable of performing not only the bread making process for making (baking) bread from wheat flour or rice flour but also the bread making process for making (baking) bread from rice grains (one form of grains) (bread making process for rice grains). Further, the automatic bread maker 1 has a feature in the control action when the bread making process for rice grains is performed so as to make bread from rice grains. Therefore, in the following description will be described while narrowing the control action to the case where the automatic bread maker 1 is used for making bread from rice grains.

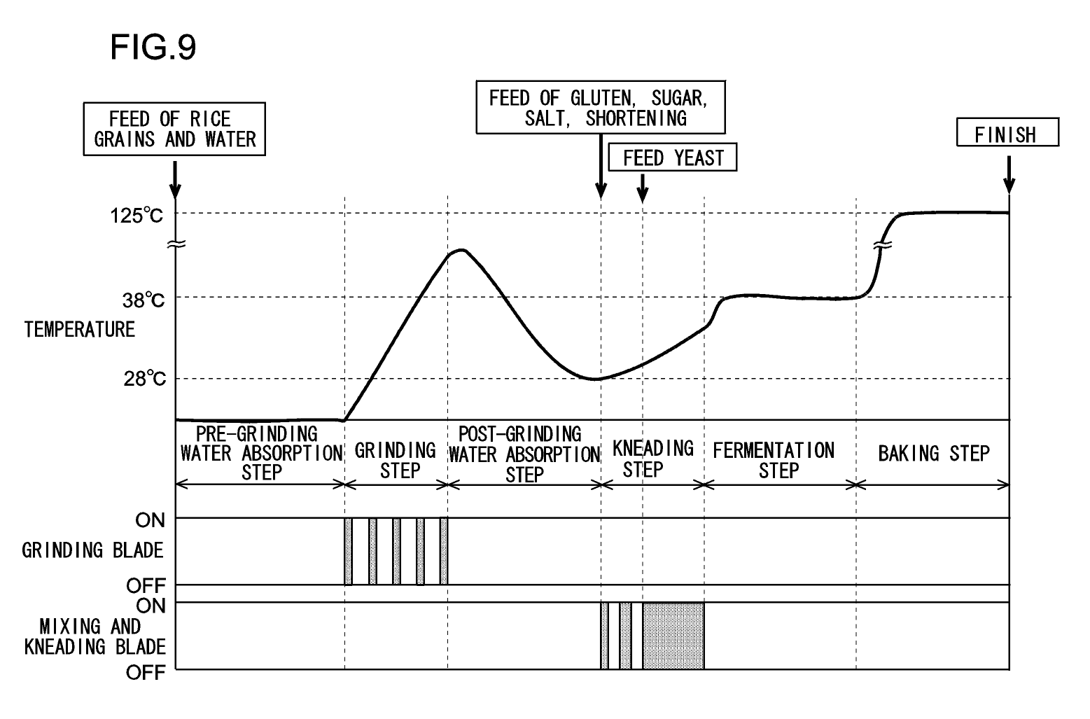

FIG. 9 is a schematic diagram illustrating a process flow of the bread making process for rice grains in the automatic bread maker of this embodiment. Note that the temperature in FIG. 9 indicates temperature of the bread container 50. As illustrated in FIG. 9, in the bread making process for rice grains, the pre-grinding water absorption step (one form of the pre-grinding liquid absorption step), the grinding step, the post-grinding water absorption step (one form of the post-grinding liquid absorption step), the kneading step, the fermentation step, and the baking step are performed sequentially in this order.

When the bread making process for rice grains is performed, the user sets the grinding blade 54 and the cover 70 with the mixing and kneading blade 72 to the bread container 50. Then, the user measures rice grains and water of predetermined amounts (for example, 220 grams of rice grains and 210 grams of water) and puts them into the bread container 50. Here, rice grains and water are mixed in this example. However, instead of simple water, liquid with taste of broth, for example, or liquid with fruit juice or alcohol may be used. The user put the bread container 50 containing rice grains and water into the baking chamber 40 and closes the lid 30. Then, the user selects the bread making process for rice grains by the operating portion 20 and presses the start key. Thus, the bread making process for rice grains is started so as to make bread from rice grains.

The pre-grinding water absorption step is a step for allowing the rice grains to absorb water (one example of liquid), so that rice grains can be ground finely in the grinding step that is performed later. The control device 81 drives the solenoid 19b so that the tip of the temperature sensor 19a contacts with the bread container 50 when the pre-grinding water absorption step is started. Thus, the control device 81 detects temperature of the bread container 50 via the temperature sensor 19a. Note that the timing for detecting temperature of the bread container 50 may be timing right after pressing of the start key, or timing a little after the same.

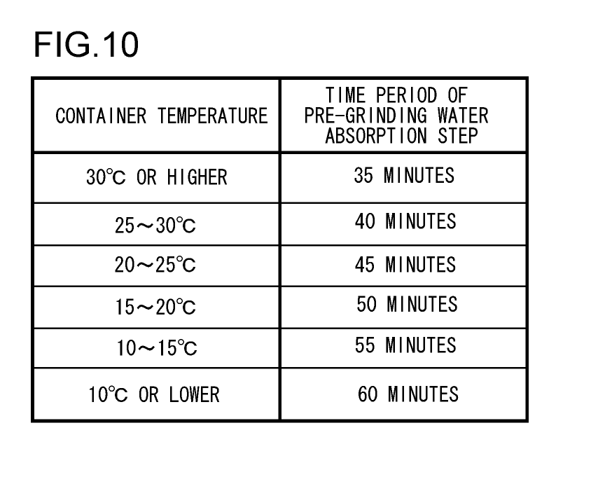

Then, the control device 81 determines a time period of the pre-grinding water absorption step on the basis of the detected temperature of the bread container 50 and a table showing values of the time period of the pre-grinding water absorption step determined in advance in association with values of container temperature (see FIG. 10). This table is stored in the ROM of the control device 81, for example. A water absorption speed of rice grains varies in accordance with water temperature. When the water temperature is high, the water absorption speed is increased. When the water temperature is low, the water absorption speed is lowered. Therefore, as this embodiment, if the temperature of the bread container 50 (reflecting the water temperature) is high, the time period of the pre-grinding water absorption step is set to a short time. If the temperature of the bread container 50 is low, the time period of the pre-grinding water absorption step is set to a long time. Thus, a variation of water absorption degree of rice grains can be reduced.

Note that the table illustrated in FIG. 10 is determined by experiment in advance so that good quality of bread can be obtained, but it is merely an example, which can modified as necessary. For instance, although the time period of the pre-grinding water absorption step is changed every five degrees centigrade in FIG. 10, this interval of temperature may be increased or decreased. In addition, an upper limit or a lower limit of the temperature may be determined as necessary.

In addition, the time period of the pre-grinding water absorption step is determined on the basis of the temperature of the bread container 50 in this embodiment, but this structure should not be interpreted as a limitation. Specifically, for example, it is possible to adopt a structure in which temperature of the bread ingredients in the bread container 50 can be measured, so that the time period of the pre-grinding water absorption step is determined on the basis of the measured temperature. Note that the water temperature is apt to increase or decrease in accordance with a season, so it is possible to adopt a structure in which the time period of the pre-grinding water absorption step is determined on the basis of ambient temperature or temperature of the baking chamber 40 (i.e., surrounding temperature of the bread container 50), for example. In this case, however, water temperature in the bread container 50 may not be reflected appropriately, so that water absorption degree of rice grains may have a variation. Therefore, it is preferable that the time period of the pre-grinding water absorption step is determined on the basis of temperature of the bread container 50 or temperature of bread ingredients in the bread container 50.

In addition, in the pre-grinding water absorption step, it is possible to rotate the grinding blade 54 in the early stage and to rotate the grinding blade 54 intermittently after that. By this way, surfaces of rice grains are scratched so that liquid absorption efficiency of rice grains can be enhanced.

When the time period of the pre-grinding water absorption step determined as described above passes (when the pre-grinding water absorption step is finished), the grinding step is performed by an instruction from the control device 81 for grinding the rice grains. In this grinding step, the grinding blade 54 rotates at high speed in the mixture of rice grains and water. Specifically, the control device 81 controls the grinding motor 64 to rotate the blade rotation shaft 52 in the reverse direction, so that the rotation of the grinding blade 54 is started in the mixture of rice grains and water. Note that the cover 70 also starts to rotate following the rotation of the blade rotation shaft 52 in this case, but the rotation of the cover 70 is soon stopped by the following action.

The rotation direction of the cover 70 accompanying the rotation of the blade rotation shaft 52 for rotating the grinding blade 54 is the clockwise direction in FIG. 5. If the mixing and kneading blade 72 is in the folded position (as illustrated in FIG. 5) before that, it becomes the extended position (as illustrated in FIG. 6) because it is resisted by the mixture of rice grains and water. When the mixing and kneading blade 72 becomes the extended position, the clutch 76 disconnects between the blade rotation shaft 52 and the cover 70 because the second engaging member 76b is separated from the rotation path of the first engaging member 76a as illustrated in FIG. 7. At the same time, the mixing and kneading blade 72 that has become the extended position abuts the inside wall of the bread container 50 as illustrated in FIG. 6, so that the rotation of the cover 70 is stopped.

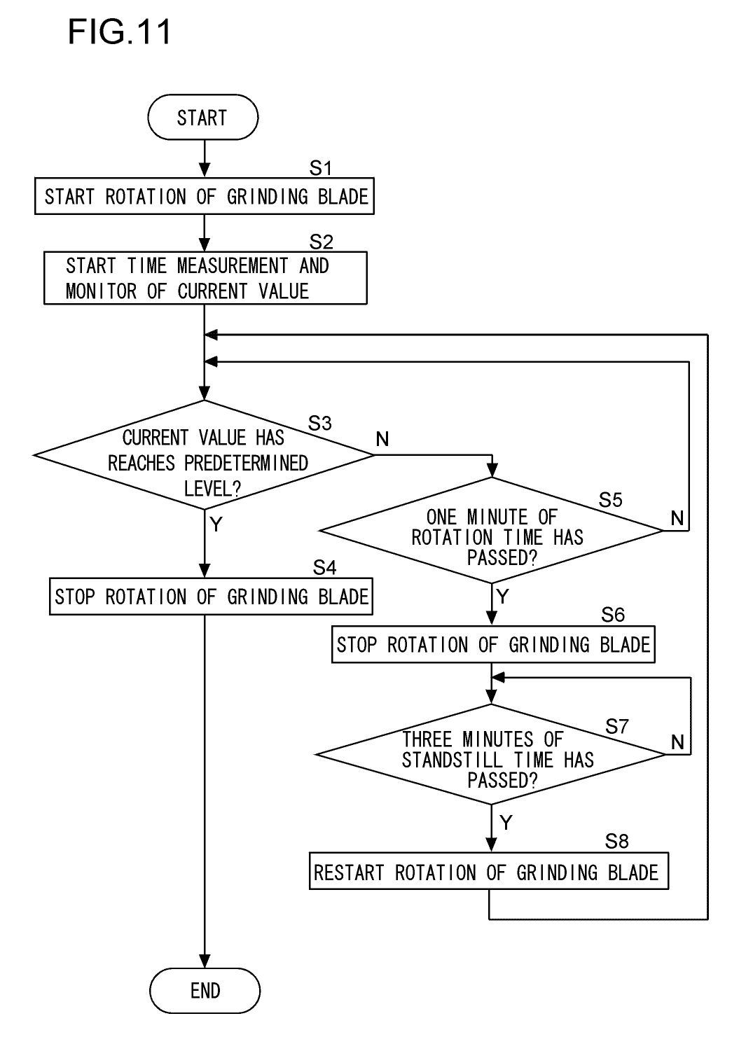

The grinding action of the rice grains performed in the grinding step is performed in the state where the rice grains are soaked with water in the pre-grinding water absorption step. Therefore, the rice grains can easily ground finely. FIG. 11 is a flowchart illustrating a detailed flow of the grinding step performed in the automatic bread maker of this embodiment. With reference to FIG. 11, the detailed flow of the grinding step will be described as follows.

When the grinding step is started, the control device 81 controls the grinding motor 64 to start the rotation of the grinding blade 54 as described above (Step S1). Substantially at the same time as the start of rotation of the grinding blade 54, the control device 81 starts to measure time and to monitor a value of control current supplied to the grinding motor 64 (Step S2). Note that the value of control current supplied to the grinding motor 64 is an example of a parameter having a correlative relationship with a load of the grinding motor 64. Further, the monitoring of the load of the grinding motor 64 is performed for detecting a ground state of the rice grains fed into the bread container 50.

When the monitoring of the control current value of the grinding motor 64 is started, the control device 81 first checks whether or not the current value has reached a predetermined level (Step S3). Here, the predetermined level is a value (current value) determined as a preferable condition for baking bread with good quality by experiment in advance, which is stored in the ROM of the control device 81, for example. If the current value has reached a predetermined level (Yes in Step S3), the control device 81 stops the rotation of the grinding blade 54 (Step S4) so that the grinding step is finished.

On the contrary, if the current value has not reached the predetermined level (No in Step S3), the control device 81 checks whether or not rotation time of the grinding blade 54 has passed one minute (Step S5). If the rotation time has not passed one minute (No in Step S5), the process goes back to Step S3, and the action described above is repeated. On the contrary, if the rotation time lasts one minute (Yes in Step S5), the control device 81 stops the rotation of the grinding blade 54 (Step S6). The control device 81 waits until a standstill period of the grinding blade 54 lasts three minutes (Step S7), and then restarts the rotation of the grinding blade 54 (Step S8). After that, the process goes back to Step S3, and the action described above is repeated.

When the grinding step is performed in this way, it is possible to maintain a substantially constant state of the mixture of water and ground flour after the grinding step (state of ground flour) even if there is a variation in the environment of the automatic bread maker 1 or in a hardness of rice grains. Therefore, the automatic bread maker 1 can reduce a variation in quality of bread.

Note that the automatic bread maker of this embodiment 1 has the structure in which it is checked whether or not the control current value of the grinding motor 64 has reached a predetermined level soon after the rotation of the grinding blade 54 is started, but this structure should not be interpreted as a limitation. Specifically, for example, the current value is apt to be unstable at an early stage after the rotation of the grinding blade 54 is started. Therefore, it is possible to check whether or not the control current value has reached the predetermined level after a lapse of a predetermined period.

In addition, there may be a case where the control current value may remain not reaching the predetermined level. As a countermeasure for such a case, it is possible to adopt a structure, for example, in which when a predetermined time passes from start of the grinding step, the grinding step is finished even if the control current value has not reached the predetermined level. In addition, as another countermeasure, it is possible to adopt a structure, for example, in which the grinding step is stopped after informing the user of the abnormal state by an error display or the like.

In addition, in this embodiment, the rotation of the grinding blade 54 is rotated in an intermittent manner by repeating the rotation (for one minute) and the standstill (for three minutes), and when the control current value of the grinding motor 64 reaches the predetermined level, the rotation action is stopped so that the grinding step is finished. However, this structure should not be interpreted as a limitation. For instance, the rotation period of the grinding blade 54 or the standstill period may be changed as necessary. In addition, the rotation of the grinding blade 54 may be continuous rotation instead of the intermittent rotation. However, the intermittent rotation can circulate the rice grains so that the grinding of rice grains can be performed uniformly. Therefore, it is preferable that the rotation of the grinding blade 54 is the intermittent rotation.

In addition, in this embodiment, the ground state of rice grains is detected by utilizing a load of the grinding motor 64. Further, as a parameter having a correlative relationship with the load of the grinding motor 64, a value of the control current supplied to the grinding motor 64 is used. However, this structure should not be interpreted as a limitation. For instance, as a parameter having a correlative relationship with the load of the grinding motor 64, a torque of the grinding motor 64, a value of electric power when the grinding motor 64 is driven, a temperature variation of the grinding motor 64, or the like may be utilized. The point is that as long as the ground state can be detected on the basis of the load of the grinding motor 64 while monitoring the load, any other structure may be adopted.

In addition, when the grinding step is performed, it is preferable that the temperature sensor 19a of the second temperature detection unit 19 is in the position without contact with the bread container 50, because vibration of the bread container 50 is large. Thus, damages to the temperature sensor 19a and the bread container 50 can be prevented.

As illustrated in FIG. 9, in the grinding step, temperature of the bread container 50 (temperature of ground flour in the bread container 50) rises due to friction in the grinding action. Then, the temperature of the bread container 50 becomes approximately 40 to 45 degrees centigrade, for example. If yeast is added so as to make bread dough in this state, the yeast does not work so that bread with good quality cannot be made. In view of this point, the automatic bread maker 1 has the post-grinding water absorption step in which the ground flour of rice grains is dipped in water and is left after the grinding step.

This post-grinding water absorption step is a step for cooling the ground flour of rice grains and for allowing the ground flour to absorb more water so that amount of fine grains increases. In this way, by increasing amount of fine grains, delicate bread can be baked. The post-grinding water absorption step may be performed only for a predetermined time period. In this case, there may be a case where temperature of the bread container 50 (bread ingredients) has a variation when the kneading step is started next due to an influence of ambient temperature, for example, so that bread with good quality cannot be obtained.

Therefore, as one countermeasure, using the first temperature detection unit 18, or the second temperature detection unit 19, ambient temperature is detected when the grinding step is finished (or before the grinding step is started), for example, and the time period of the post-grinding water absorption step is determined on the basis of the ambient temperature. Thus, variation in temperature of the bread container 50 can be reduced at the stage when the post-grinding water absorption step is finished. In the case where the second temperature detection unit 19 is used, the tip of the temperature sensor 19a is kept in a state of non-contact with the bread container 50. In other words, the second temperature detection unit 19 is used in a mode for detecting surrounding temperature of the bread container 50 (temperature of the baking chamber 40).

Specifically, for example, a relationship between the ambient temperature and the time period necessary for temperature of the bread container 50 to become an appropriate temperature (e.g., approximately 28 to 30 degrees centigrade) after the grinding step is determined so as to generate a table by experiment in advance, and the table is stored in the ROM of the control device 81. For instance, similarly to the table illustrated in FIG. 10, optimal water absorption times are determined by 5 degrees centigrade interval of the ambient temperature within a constant range, and are stored. Then, as described above, the ambient temperature is detected, the post-grinding water absorption step is performed for the time period determined on the basis of the detected temperature and the table stored in advance in the ROM of the control device 81. Note that it is necessary to increase the time period of the step if the ambient temperature is high and to decrease the time period of the step if the ambient temperature is low in the case of the post-grinding water absorption step.

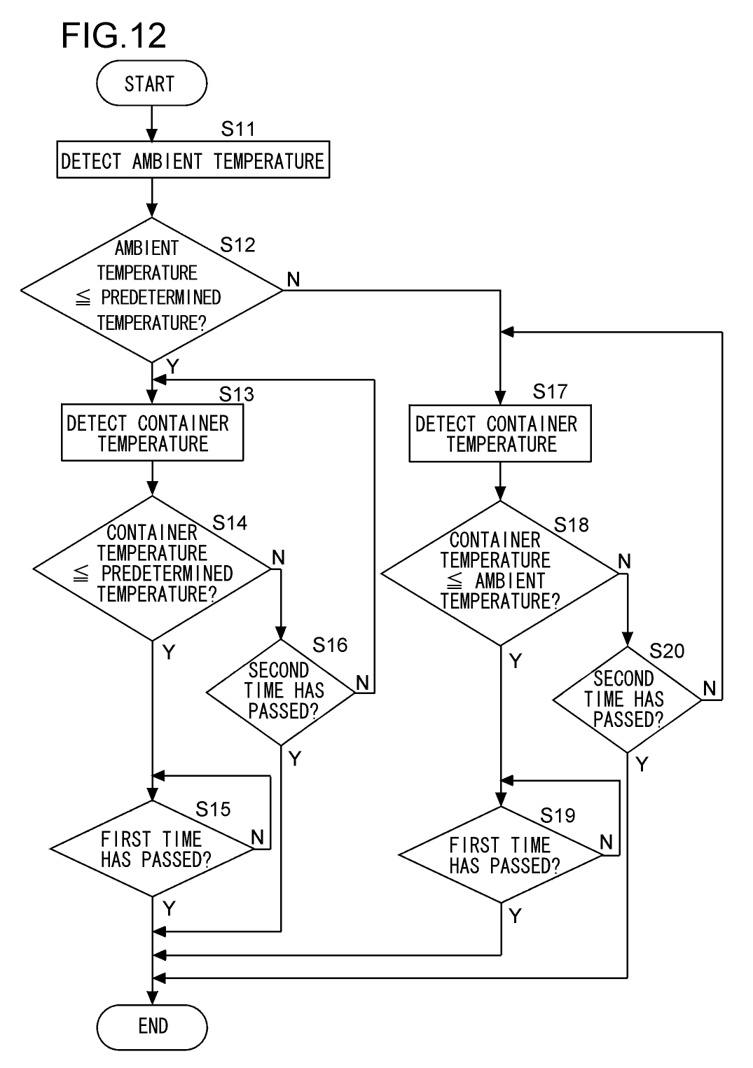

In the automatic bread maker of this embodiment 1, the post-grinding water absorption step is performed not by the above-mentioned method but by another method as illustrated in FIG. 12. Hereinafter, this method will be described.

When the grinding step finished, the control device 81 detects ambient temperature by the first temperature detection unit 18 (Step S11). It is checked whether or not the detected ambient temperature is a preset predetermined temperature or lower (Step S12). The predetermined temperature is an appropriate temperature for starting the kneading step and is set to a temperature within the range from 28 to 30 degrees centigrade, for example.

If the ambient temperature is a predetermined temperature or lower (Yes in Step S12), the control device 81 detects temperature of the bread container 50 by the second temperature detection unit 19 (Step S13). Note that the temperature is detected in the state where the tip of the temperature sensor 19a of the second temperature detection unit 19 is contacted with the bread container 50. Then, the control device 81 checks whether or not the detected temperature of the bread container 50 is the predetermined temperature or lower (Step S14).

If the detected temperature of the bread container 50 is the predetermined temperature or lower (Yes in Step S14), the control device 81 checks whether or not preset first time (e.g., 30 minutes) has passed after start of the post-grinding water absorption step (Step S15). This first time is set for preventing the time period of the post-grinding water absorption step from being too short. In other words, as described above, the post-grinding water absorption step also has a role of increasing amount of fine grains in the ground flour by allowing the ground flour obtained in the grinding step to absorb more water. Therefore, the first time is set because it is not desired that the time period of the post-grinding water absorption step becomes too short. However, if the first time is set to be too long, the ground flour is cooled too much so that a temperature variation occurs when the kneading step is started. Therefore, it is preferable to set the first time so that the above-mentioned situation does not occur. Note that it is possible to adopt a structure in which Step S15 for checking whether or not the first time has passed is not provided.

If the first time has passed from start of the post-grinding water absorption step (Yes in Step S15), the control device 81 finishes the post-grinding water absorption step. On the contrary, if the first time has not passed after start of the post-grinding water absorption step (No in Step S15), the control device 81 waits until the first time passes, and then finishes the post-grinding water absorption step.

If the detected temperature of the bread container 50 is higher than the predetermined temperature (No in Step S14), the control device 81 checks whether or not a preset second time (that is longer than the first time and is 60 minutes, for example) has passed from start of the post-grinding water absorption step (Step S16). Then, if the second time has passed (Yes in Step S16), the post-grinding water absorption step is finished even if the temperature of the bread container 50 has not reached the predetermined temperature yet. On the contrary, if the second time has not passed (No in Step S16), the process goes back to Step S13, so that the action after Step S13 is performed.

Step S16 for checking whether or not the second time has passed from start of the post-grinding water absorption step is provided for the following reason. It is considered that there is a case where it takes long time until the temperature of the bread container 50 drops below a predetermined temperature. In this case, if the kneading step is not started for a long period, the time period for making bread becomes very long so that the user may feel inconvenience. Therefore, the second time is set as an upper limit of the water absorption time so that the time period of the post-grinding water absorption step does not becomes too long. However, it is possible to adopt a structure in which Step S16 is not provided. In this case, the post-grinding water absorption step is finished after waiting until the temperature of the bread container 50 becomes the predetermined temperature.

Here, if the ambient temperature is higher than the predetermined temperature, the temperature of the bread container 50 cannot drop to the predetermined temperature in the post-grinding water absorption step. Therefore, in this case, the post-grinding water absorption step is finished as a rule when the temperature of the bread container 50 drops to the ambient temperature. In particular, the process is performed as follows.

Specifically, in Step S12, if the ambient temperature is higher than the predetermined temperature (No in Step S12), the control device 81 detects the temperature of the bread container 50 by the second temperature detection unit 19 (Step S17). Then, the control device 81 checks whether or not the detected temperature of the bread container 50 is the ambient temperature or lower (Step S18).

If the detected temperature of the bread container 50 is the ambient temperature or lower (Yes in Step S18), the control device 81 checks whether or not the first time has passed from start of the post-grinding water absorption step (Step S19). This first time is set for the same purpose as the case in Step S15. Further, it is possible to adopt a structure in which Step S19 is not provided similarly to Step S15.

If the first time has passed from start of the post-grinding water absorption step (Yes in Step S19), the control device 81 finishes the post-grinding water absorption step. On the other hand, if the first time has not passed from start of the post-grinding water absorption step (No in Step S19), the control device 81 waits until the first time passes, and then finished the post-grinding water absorption step.

If the detected temperature of the bread container 50 is higher than the ambient temperature (No in Step S18), the control device 81 checks whether or not the second time has passed from start of the post-grinding water absorption step (Step S20). Then, if the second time has passed (Yes in Step S20), the post-grinding water absorption step is finished even if the temperature of the bread container 50 has not reached the ambient temperature. On the contrary, if the second time has not passed (No in Step S20), the process goes back to Step S17, and the action after Step S17 is performed.

Note that Step S20 is provided for the same purpose as Step S16. It is possible to adopt a structure in which Step S20 is not provided similarly to Step S16. In this case, the post-grinding water absorption step is finished after waiting until the temperature of the bread container 50 becomes the ambient temperature.

In addition, in this embodiment, the time period of the post-grinding water absorption step is changed in accordance with temperature of the bread container 50. However, it is possible to adopt a structure in which the time period of the post-grinding water absorption step is changed in accordance with the temperature of the bread ingredients in the bread container 50.

In addition, in this embodiment, the time necessary for the post-grinding water absorption step (the end time of the post-grinding water absorption step) is determined on the basis of the temperature of the bread container 50 detected as necessary in the post-grinding water absorption step. Instead of this structure, it is possible to adopt a structure in which the ambient temperature and the temperature of the bread container 50 are detected when the post-grinding water absorption step is started, for example, and the time period necessary for the post-grinding water absorption step is determined on the basis of a drop rate of the temperature of the bread container 50 expected from the ambient temperature (that is necessary to be determined by experiment in advance) and the temperature of the bread container 50.

When the post-grinding water absorption step is finished, the kneading step is performed next. When the kneading step is started, gluten and seasoning such as salt, sugar and shortening are fed by predetermined amounts (for example, 50 grams of gluten, 16 grams sugar, 4 grams of salt, and 10 grams of shortening) into the bread container 50. This feed may be performed by the user, for example, or be performed by an automatic feeding machine without bothering the user.

Note that gluten is not essential as bread ingredient. Therefore, it may be determined whether or not to add gluten to the bread ingredients in accordance with taste. In addition, it is possible to add thickening stabilizing agent (e.g., Guar gum) instead of gluten.

When the kneading step is started, the control device 81 controls the mixing and kneading motor 60 to rotate the blade rotation shaft 52 in the normal direction. When the cover 70 rotates in the normal direction (counterclockwise direction in FIG. 6) following the rotation of the blade rotation shaft 52 in the normal direction, the mixing and kneading blade 72 is resisted by the bread ingredients in the bread container 50 and changes its position from the extended position (see FIG. 6) to the folded position (see FIG. 5). As a result, as illustrated in FIG. 4, the clutch 76 connects the blade rotation shaft 52 to the cover 70 when it becomes an angle such that the second engaging member 76b interferes with the rotation path of the first engaging member 76a. Thus, the cover 70 and the mixing and kneading blade 72 become integral with the blade rotation shaft 52 and rotates in the normal direction. Note that the mixing and kneading blade 72 rotates at a low speed and a high torque.

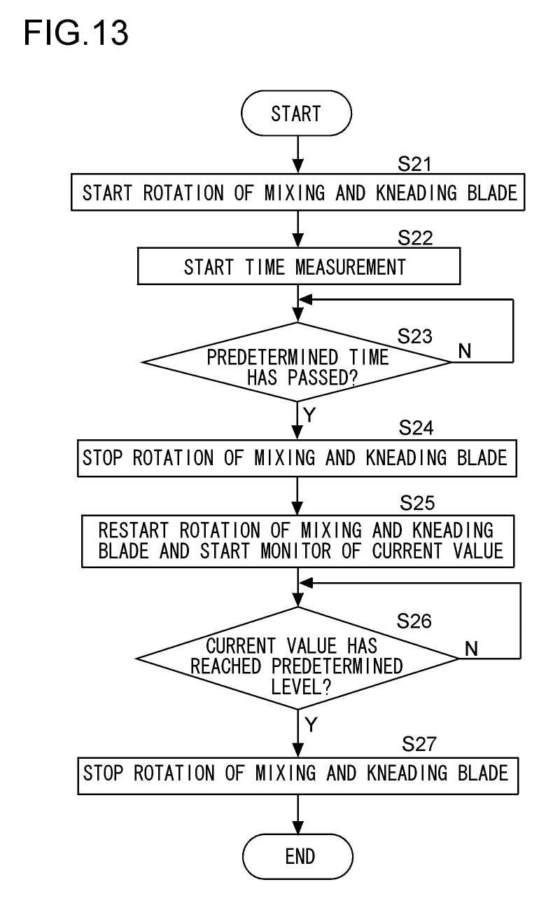

When the mixing and kneading blade 72 rotates, the bread ingredients are mixed and kneaded to be dough having predetermined elasticity. When the mixing and kneading blade 72 waves and smashes the dough to the inside wall of the bread container 50, “kneading” action is added to the mixing action. FIG. 13 is a flowchart illustrating a detailed flow of the kneading step performed in the automatic bread maker of this embodiment. With reference to FIG. 13, the detailed flow of the kneading step will be described as follows.

When the post-grinding water absorption step is finished and gluten or seasoning is fed into the bread container 50, the control device 81 controls the mixing and kneading motor 60 to start rotation of the mixing and kneading blade 72 (Step S21). In addition, substantially at the same time as the rotation start of the mixing and kneading blade 72, the control device 81 starts measurement of time (Step S22). The bread ingredients in the bread container 50 is mixed and kneaded by the mixing and kneading blade 72 until a predetermined time passes from the measurement of time (Step S23). Note that, to be accurate, the rotation of the mixing and kneading blade 72 in the period is performed in an intermittent manner in this embodiment. However, the rotation of the mixing and kneading blade 72 in the period may be performed in a continuous manner.

When a predetermined time passes, the control device 81 stops rotation of the mixing and kneading blade 72 (Step S24). Then, while the mixing and kneading blade 72 is stopped, yeast (e.g., dry yeast) is fed. This yeast may be fed by the user or may be fed automatically by an automatic feeding machine. Note that the yeast should not be fed together with the gluten in order to prevent the yeast (dry yeast) from contacting directly with water as much as possible and to prevent the yeast from being scattered. However, it may be possible to fed the yeast simultaneously with the gluten or the like in a special case.

When yeast is fed while the mixing and kneading blade 72 is stopped, the control device 81 restarts rotation of the mixing and kneading blade 72 and starts to monitor a value of control current supplied to the mixing and kneading motor 60 (Step S25). In this embodiment, after the yeast is fed, the mixing and kneading blade 72 is rotated in a continuous manner. When the mixing and kneading blade 72 is rotated, the control device 81 checks whether or not the current value has reached a predetermined level (Step S26). This checking is performed until the current value reaches the predetermined level. Then, the control device 81 stops the rotation of the mixing and kneading blade 72 when the current value reaches the predetermined level (Step S27), so that the kneading step is finished.

Note that the predetermined level is a value (current value) that is determined by experiment in advance as a condition for baking bread with good quality, and is stored in the ROM of the control device 81, for example. In addition, the value of control current supplied to the mixing and kneading motor 60 is an example of a parameter having a correlative relationship with the load of the grinding motor 60. Other than that, for example, a torque of the mixing and kneading motor 60, a value of electric power when the mixing and kneading motor 60 is driven, a variation in temperature of the mixing and kneading motor 60, or the like may be used as the parameter. Note that a load of the mixing and kneading motor 60 is monitored in order to detect a state of the bread dough in the bread container 50.

Note that the automatic bread maker 1 of this embodiment has a structure in which it is checked whether or not a value of control current of the mixing and kneading motor 60 has reached a predetermined level soon after start of the rotation of the mixing and kneading blade 72, but this structure should not interpreted as a limitation. Specifically, for example, the current value is apt to become unstable in the early stage after restarting the rotation of the mixing and kneading blade 72. Therefore, it is possible to check whether or not the control current value has reached the predetermined level after a predetermined period passes.

In addition, in some cases, the control current value may remain not reaching the predetermined level. As a countermeasure for such a case, it is possible to adopt a structure, for example, in which when a predetermined time passes from start of the rotation of the mixing and kneading blade 72, the kneading step is finished even if the control current value has not reached the predetermined level. In addition, as another countermeasure, it is possible to adopt a structure, for example, in which the kneading step is stopped after informing the user of the abnormal state by an error display or the like.

In addition, in this kneading step of the automatic bread maker 1, the control device 81 controls the sheath heater 41 to adjust so that temperature of the baking chamber 40 becomes a predetermined temperature (e.g., 32 degrees centigrade). In this case, the tip of the temperature sensor 19a of the second temperature detection unit 19 is in the position without contact with the bread container 50. Therefore, in the kneading step in which the bread container 50 is vibrated largely, a damage to the temperature sensor 19a or the bread container 50 hardly occurs. In addition, in order to bake bread containing ingredients (e.g., raisins), the ingredients should be fed during the kneading step.

When the kneading step is finished, the control device 81 instructs to perform the fermentation step next. In this fermentation step, the control device 81 controls the sheath heater 41 so that temperature of the baking chamber 40 becomes temperature for fermentation (fermentation temperature). Further, it is found that there is a difference of time until reaching the fermentation temperature depending on temperature of the environment (ambient temperature) where the automatic bread maker 1 is placed. Therefore, if the time period of the fermentation step is fixed to a predetermined time, a variation of quality may occur in fermentation of bread dough.

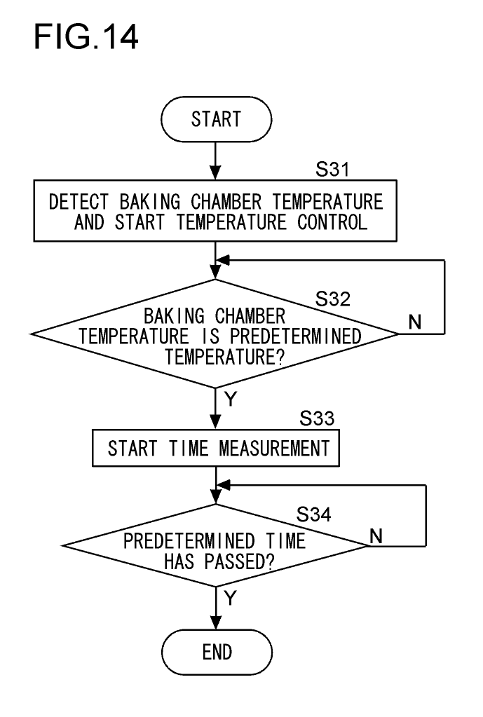

Therefore, in the automatic bread maker 1, the control device 81 controls to perform the fermentation step in accordance with the flowchart illustrated in FIG. 14. First, when the kneading step is finished, the control device 81 starts to detect temperature of the baking chamber 40 and starts the temperature control so as to control the sheath heater 41 so that temperature of the baking chamber 40 becomes a predetermined fermentation temperature (e.g., 38 degrees centigrade) (Step S31). Note that temperature of the baking chamber 40 is detected in the state where the temperature sensor 19a is apart from the bread container 50 by stopping drive of the solenoid 19b of the second temperature detection unit 19.

Then, the control device 81 monitors temperature of the baking chamber 40 until the temperature of the baking chamber 40 becomes a predetermined temperature (Step S32). Note that this predetermined temperature is 38 degrees centigrade, for example. When temperature of the baking chamber 40 becomes the predetermined temperature, time measurement is started (Step S33). Then, it is checked whether or not a predetermined time (e.g., 50 minutes) has passed from start of the measurement (Step S34). When the predetermined time passes, the fermentation step is finished. Note that the control device 81 controls the sheath heater 41 so that temperature of the baking chamber 40 is kept to be the predetermined temperature from start of the time measurement to end of the fermentation step.

When the fermentation step is performed as described above, fermentation time of bread dough at the predetermined temperature can be constant regardless of the environment where the automatic bread maker 1 is placed. Note that the automatic bread maker of this embodiment 1 has a structure in which end of the fermentation step is decided by detecting temperature of the baking chamber 40 (surrounding temperature of the bread container 50), but this structure should not be interpreted as a limitation. It is possible to adopt a structure in which end of the fermentation step is decided by detecting temperature of the bread container 50 or temperature of the bread ingredients in the bread container 50 (more accurately, bread dough temperature).

In addition, the fermentation step may be performed by a process flow other than the process flow described above. For instance, by experiment in advance, a relationship between ambient temperature and optimal time for the fermentation step is studied so as to generate a table, and ambient temperature is detected (by the first temperature detection unit 18) when the fermentation step is started, so that time for the fermentation step is determined on the basis of the detected ambient temperature and the table (within the range from 50 to 70 minutes, for example). Then, the fermentation step is performed for the determined time. If the ambient temperature is high, the time for the fermentation step becomes short. If the ambient temperature is low, the time for the fermentation step becomes long. Note that the table that is used here should be stored in the ROM of the control device 81.

In addition, in some cases, a gas venting process or a dough rounding process may be performed during this fermentation step.

When the fermentation step is finished, the control device 81 instructs to perform the baking step. The control device 81 controls the sheath heater 41 so that temperature of the baking chamber 40 increases up to a temperature for baking bread (e.g., 125 degrees centigrade), and performs the bread baking process in the baking environment for a predetermined time (50 minutes in this embodiment). The end of the baking step is informed to the user by display on the liquid crystal display panel (not shown) of the operating portion 20 or an announcement sound, for example. When it is detected that bread making process has been completed, the user opens the lid 30 and takes out the bread container 50.

Further, also in this baking step, there may be a difference of time until reaching the temperature for baking bread depending on temperature of the environment (ambient temperature) where the automatic bread maker 1 is placed. Therefore, it is possible to adopt a structure in which the time for the baking step is changed on the basis of ambient temperature in this baking step, too.

As described above, the automatic bread maker 1 of this embodiment is very convenient because it can bake bread from rice grains. Further, the bread making process for rice grains is devised to be hardly affected by variation of temperature of environment where the automatic bread maker 1 is placed or variation of hardness of rice grains to be used. Therefore, the automatic bread maker 1 can make bread with good quality from rice grains in a stable manner.

Note that the automatic bread maker described above is merely an example of the present invention, so the structure of the automatic bread maker to which the present invention is applied is not limited to the embodiment described above.

For instance, although bread is made from rice grains in the embodiment described above, the present invention can also be applied to a case where bread is made from grains other than rice grains, which include wheat, barley, millet, barnyard millet, buckwheat, corn, and soybean.

In addition, in the embodiment described above, a load of motor (specifically, current value) is monitored in the grinding step and in the kneading step, so that end of the active step is decided on the basis of the load in both steps. However, it is possible to adopt a structure in which end of the active step is decided on the basis of the load of motor in one of the steps.

For instance, if end of the active step is not decided on the basis of the load of motor in the kneading step, the kneading step may be performed as follows. Specifically, when the kneading step is started, the first temperature detection unit 18 detects the ambient temperature. Then, time for the kneading step is decided on the basis of the detected ambient temperature and a table indicating time for the kneading step determined in advance in association with the ambient temperature. This table is stored in the ROM of the control device 81, for example. The quality of bread dough obtained by the kneading step is susceptible to influence of temperature of the environment where the automatic bread maker 1 is placed, but with the structure described above, it is possible to reduce a variation of quality of bread due to variation of the ambient temperature. Note that it is possible to adopt a structure in which time for the kneading step is determined on the basis of surrounding temperature of the bread container 50 (e.g., temperature of the baking chamber 40) instead of determining time for the kneading step on the basis of ambient temperature.

In addition, the embodiment described above has a structure in which time period of the step is changed on the basis of temperature detected by the temperature detection unit in the pre-grinding water absorption step, the post-grinding water absorption step, and the fermentation step. However, this structure should not be interpreted as a limitation. It is possible to adopt a structure in which time period of the step is fixed to a predetermined time in one or two of the above-mentioned three steps.

In addition, the bread making process for rice grains described above is an example, and other making process may be adopted. For instance, in the embodiment described above, the water absorption step is performed before and after the grinding step for making bread from rice grains. However, it is possible to adopt a structure in which the water absorption step is not performed.

In addition, in the embodiment described above, the automatic bread maker 1 has two blades, namely the grinding blade 54 and the mixing and kneading blade 72, and the motors are disposed for the blades, respectively. However, without limiting to this structure, the same blade may be used in the grinding step and the kneading step, or the same motor is used in the grinding step and the kneading step. In addition, the bread making process performed by the automatic bread maker may be only the bread making process for rice grains.

What is claimed is:

1. An automatic bread maker comprising:
a container in which bread ingredients are fed;
a main body which receives the container and is equipped with a motor; and
a control unit which controls to perform a bread making process in a state where the container is received by the main body, wherein
the bread making process includes a grinding step of grinding grains in the container by driving the motor, and a kneading step of kneading bread ingredients in the container including the ground flour of the grains into bread dough by driving the motor, and
the control unit monitors a load of the motor so as to decide end of the active step on the basis of the load in at least one of the grinding step and the kneading step.

2. An automatic bread maker according to claim 1, wherein the bread making process further includes a fermentation step of fermenting the kneaded bread dough, and a baking step of baking the fermented bread dough.

3. An automatic bread maker according to claim 1, wherein the bread making process further includes a pre-grinding liquid absorption step of allowing the grains in the container to absorb liquid before the grinding step.

4. An automatic bread maker according to claim 1, wherein the bread making process further includes a post-grinding liquid absorption step of allowing the ground flour of the grains in the container to absorb liquid between the grinding step and the kneading step.

5. An automatic bread maker according to claim 1, further comprising a temperature detection unit capable of detecting at least one of ambient temperature, temperature of the container, surrounding temperature of the container, and temperature of the bread ingredients in the container, wherein
the plurality of steps performed when the bread making process is performed include at least one step whose time period is changed on the basis of temperature detected by the temperature detection unit.

6. An automatic bread maker according to claim 1, wherein the motor includes a grinding motor that is used in the grinding step and a mixing and kneading motor that is used in the kneading step.

7. An automatic bread maker comprising:
a container in which bread ingredients are fed;
a main body which receives the container and is equipped with a motor; and
a control unit which controls to perform a bread making process in a state where the container is received by the main body, wherein
the bread making process includes a pre-grinding liquid absorption step of allowing the grains in the container to absorb liquid before the grinding step, a grinding step of grinding grains in the container by driving the motor, a post-grinding liquid absorption step of allowing the ground flour of the grains in the container to absorb liquid, kneading step of kneading bread ingredients in the container including the ground flour of the grains into bread dough by driving the motor, a fermentation step of fermenting the kneaded bread dough, and a baking step of baking the fermented bread dough, and
the control unit monitors a load of the motor so as to decide end of the active step on the basis of the load in at least one of the grinding step and the kneading step.

8. An automatic bread maker according to claim 7, further comprising a temperature detection unit capable of detecting at least one of ambient temperature, temperature of the container, surrounding temperature of the container, and temperature of the bread ingredients in the container, wherein
the plurality of steps performed when the bread making process is performed include at least one step whose time period is changed on the basis of temperature detected by the temperature detection unit.

9. An automatic bread maker according to claim 7, wherein the motor includes a grinding motor that is used in the grinding step and a mixing and kneading motor that is used in the kneading step.
